(19) United States
(12) Patent Application Publication
(10) Pub. No.: US 2026/0147695 A1
(43) Pub. Date: May 28, 2026

(54) SYSTEM AND METHODS FOR SIMULATING INTEGRATION TESTING OF DATA PIPELINES

(71) Applicant: State Farm Mutual Automobile Insurance Company, Bloomington, IL (US)

(72) Inventor: Jonathan B. CHANCE, Chandler, AZ (US)

(73) Assignee: State Farm Mutual Automobile Insurance Company, Bloomington, IL (US)

(21) Appl. No.: 18/974,021

(22) Filed: Dec. 9, 2024

Related U.S. Application Data
(60) Provisional application No. 63/725,604, filed on Nov. 27, 2024.

(51) Int. Cl. G06F 11/3668; G06F 11/07

(52) U.S. Cl. CPC G06F 11/3688; G06F 11/0793; G06F 11/3692

(57) ABSTRACT

Systems and methods for simulating and executing configurable workflows for integration testing of data pipelines are disclosed. The method may include, such as by one or more processors: (1) receiving workflow configuration data corresponding to a data pipeline; (2) executing processes in the data pipeline by (i) accessing each process in the workflow configuration data, (ii) retrieving a corresponding script for each process, (iii) installing dependencies for each process, (iv) executing a main function of the script by passing input argument(s) and data elements, and/or (v) capturing execution log(s) and storing output data; (3) detecting an error during execution of the processes; (4) in response to the detecting, pausing a subsequent execution of the data pipeline; (5) analyzing the workflow configuration data to determine a starting process; (6) resuming the execution of the data pipeline from the starting process; and/or (7) generating a notification summarizing execution outcomes for each process.

### CROSS-REFERENCE TO RELATED APPLICATION

This patent application claims the benefit of priority to U.S. Provisional Application No. 63/725,604, filed on November 27, 2024, the entirety of which is incorporated herein by reference.

### TECHNICAL FIELD

This present disclosure relates generally to the field of testing and simulation of data workflows. In particular, the present disclosure relates to simulating integration tests of data pipelines for error detection, debugging, and generating reports to optimize data pipeline performance.

### BACKGROUND

The integration and execution of data pipelines may pose significant technical challenges, particularly when it comes to ensuring reliability, efficiency, and performance. As data pipelines may include multiple interconnected processes, errors may arise at various stages, often requiring a full re-execution of the pipeline to identify and resolve issues. For example, when developing a data pipeline, it may be crucial to thoroughly test each component of the data pipeline to ensure that the code functions as expected and operates efficiently. However, this may become challenging when dependencies are involved, as errors in one process of the data pipeline may have a cascading effect upon subsequent processes. The reliance upon these dependencies may complicate testing, because failure in one process may require that the entire pipeline should be re-executed from the beginning, prolonging the debugging process.

The need for effective error handling and debugging is crucial, as conventional methods may be time-consuming and prone to errors. For example, each time an error occurs, the entire pipeline may be re-executed from the beginning, even if the error is confined to a single process. This method may be highly inefficient, especially when working with large datasets or intricate workflows, as it may consume significant computational resources and time. This repetitive cycle of error identification, re-execution, and debugging may impede the development process, making it difficult to isolate and resolve issues. Consequently, this method may slow down the data pipeline optimization, prolonging the time to deployment and reducing the overall system efficiency. Conventional techniques may include additional inefficiencies, encumbrances, ineffectiveness, and drawbacks, as well.

### SUMMARY

The present embodiments may relate, inter alia, to solving one or more technical challenges, such as those discussed above and elsewhere herein. Specifically, the present computer systems and computer-implemented methods may solve technical challenges by (i) implementing targeted error detection and isolating errors to specific processes, facilitating the identification and resolution of issues without the need for full pipeline rerun, (ii) resuming execution from a specified point in the pipeline to bypass previously successful processes and focus upon processes that require re-execution, and/or (ii) optimizing the resource usage through the shared initialization and dependency management.

In one aspect, a computer-implemented method for simulating and executing configurable workflows for integration testing of data pipelines may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources.

The computer-implemented method may include, via one or more processors, transceivers, sensors, and/or other components: (1) receiving, by one or more processors, workflow configuration data corresponding to a data pipeline, wherein the workflow configuration data specifies data for executing a series of sequential processes within the data pipeline; (2) executing, by the one or more processors, one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores; (3) detecting, by the one or more processors, an error during execution of the one or more processes; (4) in response to the detecting, pausing, by the one or more processors, a subsequent execution of the data pipeline; (5) analyzing, by the one or more processors, the workflow configuration data to determine a specified starting process; (6) resuming, by the one or more processors, the execution of the data pipeline from the specified starting process to bypass the execution of one or more previously completed processes; and/or (7) generating, by the one or more processors, a notification summarizing one or more execution outcomes for each process in the data pipeline. The method may include additional, less, or alternate functionality, including that discussed elsewhere herein.

In another aspect, a computer system for simulating and executing configurable workflows for integration testing of data pipelines may be provided. The computer system may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations. The system may include, via one or more processors, non-transitory computer readable medium, transceivers, sensors, and/or other components to perform operations that may include: (1) receiving workflow configuration data corresponding to a data pipeline, wherein the workflow configuration data specifies data for executing a series of sequential processes within the data pipeline; (2) executing one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores; (3) detecting an error during execution of the one or more processes; (4) in response to the detecting, pausing a subsequent execution of the data pipeline; (5) analyzing the workflow configuration data to determine a specified starting process; (6) resuming the execution of the data pipeline from the specified starting process to bypass the execution of one or more previously completed processes; and/or (7) generating a notification summarizing one or more execution outcomes for each process in the data pipeline. The system may include additional, less, or alternate functionality, including that discussed elsewhere herein.

In yet another aspect, a non-transitory computer readable medium for simulating and executing configurable workflows for integration testing of data pipelines may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations. The non-transitory computer readable medium may include, via one or more processors, transceivers, sensors, and/or other components: (1) receiving, by one or more processors, workflow configuration data corresponding to a data pipeline, wherein the workflow configuration data specifies data for executing a series of sequential processes within the data pipeline; (2) executing, by the one or more processors, one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores; (3) detecting, by the one or more processors, an error during execution of the one or more processes; (4) in response to the detecting, pausing, by the one or more processors, a subsequent execution of the data pipeline; (5) analyzing, by the one or more processors, the workflow configuration data to determine a specified starting process; (6) resuming, by the one or more processors, the execution of the data pipeline from the specified starting process to bypass the execution of one or more previously completed processes, and/or (7) generating, by the one or more processors, a notification summarizing one or more execution outcomes for each process in the data pipeline. The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a diagram showing an exemplary architecture diagram for simulating integration tests of a data pipeline, according to certain aspects of the disclosure.

FIG. 2 is an exemplary flowchart of a computer-implemented or computer-based process for simulating and executing configurable workflows for integration testing of data pipelines, according to certain aspects of the disclosure.

FIG. 3 is an exemplary flowchart of a computer-implemented or computer-based process for simulating the execution of a data pipeline with error handling and report generation, according to certain aspects of the disclosure.

FIG. 4 illustrates an implementation of an exemplary computer system that executes techniques presented herein.

Advantages will become more apparent to those skilled in the art from the following description of the preferred embodiments that have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that may solve technical challenges by (i) implementing targeted error detection and isolating errors to specific processes, facilitating the identification and resolution of issues without the need for full pipeline rerun, (ii) resuming execution from a specified point in the pipeline to bypass previously successful processes and focus upon the processes that require re-execution, and/or (iii) optimizing resource usage through shared initialization and dependency management.

In large-scale data pipelines, technical challenges may arise from the complexity and interdependence of the various processes that make up the pipeline. These processes may rely upon each other in a chain, where an error in one step may trigger failures downstream. This tight coupling of dependencies may make it difficult to isolate errors and address them efficiently. Traditional methods of debugging data pipelines typically involve rerunning the entire pipeline from the start after an error may be identified. This may be particularly problematic when working with big data, where each pipeline execution may be time-consuming and resource-intensive, requiring substantial computational power and storage to process large datasets.

The need to restart the entire pipeline with every error occurrence may lead to inefficiencies that are exacerbated in complex workflows. For example, for each failed run, the user (e.g., coder) may have to wait for the pipeline to process the entire data flow again, even if the failure is confined to a single step or process. This may result in significant delays, particularly in cases where the pipeline may include multiple stages of transformation or enrichment, each processing large volumes of data. Moreover, because conventional methods do not provide granular insights into the specific point of failure, users often have to guess where the problem occurred and experiment with various fixes, leading to increased time and effort spent upon troubleshooting.

Additionally, the conventional methods may not address the inherent challenges of managing dependencies between processes in a data pipeline. For example, an output of one process may include the input for subsequent processes, hence an error in an earlier stage may corrupt the entire data flow, making it technically challenging to execute later processes without first resolving the issues. This may necessitate a full pipeline restart even when the failure is isolated. Without efficient mechanisms to handle such dependencies and resume the pipeline from the point of failure, such traditional methods may struggle to provide the level of flexibility and control required for effective troubleshooting.

When errors are detected, traditional approaches may often need restarting the entire pipeline, which may be time-consuming and resource-intensive. The conventional methods are especially problematic in workflows with tight interdependencies, where a failure in one process may propagate and cause additional issues down the line. As a result, the pipeline may be re-executed from the beginning, making it difficult to quickly isolate the root cause of the error. This not only hampers development speed, but may also limit the ability to optimize the pipeline efficiently. Such limitations of the traditional methods make them unsuitable for modern data pipelines, which may need speed, scalability, and efficiency to handle increasing data volumes and complexity. There is a need for advanced solutions that may allow for targeted error resolution, minimize unnecessary reprocessing, and/or improve the overall speed and reliability of data pipeline management.

### EXEMPLARY COMPUTER SYSTEM

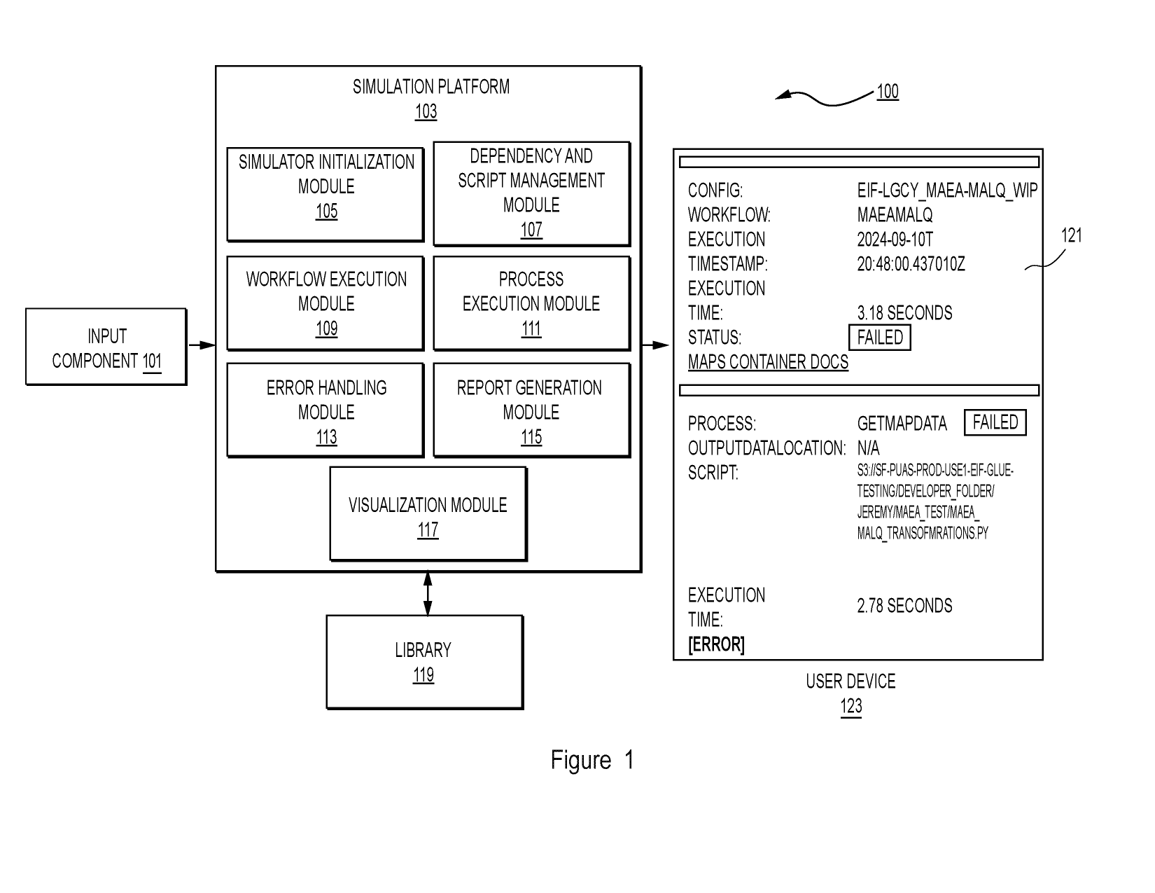

To address technical challenges, such as the above, computing system 100 of FIG. 1 may execute each process independently, ensuring that processes are sequentially executed in isolation. If an error arises within any specific process, the computing system 100 may halt execution at that point. Such a targeted error-capture mechanism may enable the identification of the exact state and cause of an error without necessitating a complete rerun of the entire pipeline. By confining errors to individual processes, the computing system 100 may allow for efficient troubleshooting, where only the failed processes (or a specified restart process) may be rerun. For example, the computing system 100 may allow users to specify a particular process from which execution should resume. This configurable restart point is particularly beneficial when users need to make targeted adjustments following an error. By invoking the run_workflow function with a specified start process, users may bypass previously successful stages, focusing only upon portions of the pipeline that require re-execution. This selective rerun capability may minimize both execution time and computational resources, making the debugging and testing process highly efficient.

The computing system 100 may leverage a shared initialization approach, whereby resources and dependencies are loaded once at the start of the pipeline execution. This initial setup phase may allocate all necessary resources across processes, ensuring that each subsequent process may reuse these resources without requiring redundant boot-up or loading times. Such a shared initialization framework may enhance performance efficiency, especially for resource-intensive workflows. To further streamline execution, the computing system 100 may store necessary dependencies and executable scripts within a dedicated “Lib” folder, should a rerun be required. There may be no need to reinstall dependencies or reload scripts, as they are readily accessible within the cache. This may allow each process to independently restart as needed without incurring repetitive setup times, significantly reducing downtime between executions and enabling quicker recovery from errors.

The computing system 100 may generate a comprehensive report (e.g., HTML report) that consolidates key information from each process’s execution upon completion of the pipeline or upon encountering an error. This report may include process-specific output, logs, and error messages, offering a detailed overview that may facilitate root cause analysis for debugging. Additionally, the computing system 100 may provide real-time logging for each process, enabling users to actively monitor pipeline progress and instantly identify issues as they arise. Such a combination of detailed reporting and real-time feedback may expedite the troubleshooting process.

FIG. 1 depicts a diagram showing an exemplary architecture diagram for simulating integration tests of a data pipeline, according to certain aspects of the disclosure. FIG. 1 may include an input component 101, a simulation platform 103, and/or a user device 123. It should be understood that other implementations of computing system 100 may omit one or more of the foregoing components and/or may include additional components, as the case may be.

In one instance, the input component 101 may include an entry point for user-defined pipeline configurations and parameters, facilitating the ingestion and configuration of workflows. The input component 101 may serve as the primary interface through which users may specify pipeline parameters, including the workflow configuration file in JSON format, sample size of data, and a starting process. The configuration file may define the pipeline structure, listing each process to be executed sequentially, along with the associated scripts, dependencies, input data paths, output data paths, and other runtime parameters. By allowing users to specify sample size for data testing and a starting process, the input component 101 may provide enhanced flexibility, enabling the execution to resume from a specific point in the pipeline without re-running preceding processes. This capability may optimize resource usage and shorten debugging cycles, especially in scenarios where complex workflow requires iterative testing.

In one instance, the simulation platform 103 may include an integrated environment configured to simulate and streamline (extract, transform, and load) ETL pipeline workflows, providing users with tools for testing, debugging, and optimizing data processing tasks. The simulation platform 103 may support the complete execution of the ETL processes, enabling end-to-end workflow management in a virtualized environment that may mirror production settings (e.g., the actual production environment in which the data pipeline would typically run). By simulating each stage of the pipeline, the simulation platform 103 may allow users to detect and address errors, evaluate performance, and verify data processing outcomes without affecting live systems.

The simulation platform 103 may handle different pipeline configurations and sample sizes, giving users the flexibility to test various scenarios and data volumes. This may facilitate the identification of potential bottlenecks, dependency issues, or performance-related challenges within the workflow. The simulation platform 103 may ensure that each process in the pipeline is executed in sequence, mirroring the behavior of a real-world ETL pipeline, with the added benefit of allowing the users to start the execution from a specific process. This capability may reduce redundancy, eliminating the need to rerun the entire pipeline after an error occurs.

In one instance, the simulation platform 103 may include mechanisms for automated error detection and handling, providing users with real-time feedback upon any issues that may arise during execution. In cases where errors are detected, the simulation platform 103 may automatically generate recommendations for troubleshooting and corrective actions. The simulation platform 103 may also produce a detailed HTML report summarizing the execution outcomes, including encountered errors, successful process executions, and a sample of output data. This report may aid in understanding the flow of data, pinpointing the root cause of issues, and ensuring that the pipeline performs optimally.

In one instance, the simulation platform 103 may comprise a simulator initialization module 105, a dependency and script management module 107, a workflow execution module 109, a process execution module 111, an error handling module 113, a report generation module 115, and a visualization module 117, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the simulator initialization module 105 may serve as the starting point for configuring and preparing the simulator to execute the ETL pipeline workflow. Upon receiving a JSON configuration file from the input component 101, the simulator initialization module 105 may load all necessary details, including the sequential order of process, specific parameters for each process, and optional user settings such as sample size or designated starting process. The simulator initialization module 105 may set up a logging configuration to capture and display real-time execution logs, giving users insight into the pipeline’s progress. By configuring the environment, setting process parameters, and enabling logging, the simulator initialization module 105 may provide a strong foundation for executing the ETL workflow, enhancing the efficiency of testing and troubleshooting.

In one instance, the dependency and script management module 107 may ensure that each process in the ETL pipeline has access to the necessary dependencies and scripts for seamless execution. The dependency and script management module 107 may identify any dependencies specified in the workflow configuration file for each process, and then dynamically install them within the simulator environment. Such dynamic installation may ensure that all required libraries and packages are available, reducing potential compatibility issues and allowing each process to run without interruptions. The dependency and script management module 107 may retrieve and store the scripts associated with each process in a designated library 119, organizing them for easy and efficient access throughout the workflow. During execution, the dependency and script management module 107 may retrieve each script on-demand, loading it directly from the library 119. This process may optimize performance by avoiding redundant downloads and making each process’s scripts immediately accessible, ultimately improving overall execution speed.

In one instance, the workflow execution module 109 may coordinate the sequential execution of each process within the ETL pipeline workflow. Once the simulator is configured, the workflow execution module 109 may iterate through the list of processes specified in the workflow configuration file, managing the workflow’s flow based upon the defined order. For each process, the workflow execution module 109 may retrieve the corresponding script and dependencies, as prepared by the dependency and script management module 107, and may execute the script by invoking its main function with the specified input parameters.

If the user has defined a specific starting point within the pipeline, the workflow execution module 109 may begin execution from that process, bypassing prior processes and saving time by avoiding redundant operations. During each step, the workflow execution module 109 may monitor the execution status, capturing and relaying any logs in real-time to provide users with immediate feedback upon the process flow and any intermediate results. In cases where a process encounters an error, the workflow execution module 109 may halt further execution and initiate the error-handling routines to manage the failure. This may include signaling the report generation module 115 to generate a report (e.g., HTML report) capturing the error details and any available process outputs up to that point.

In one instance, the process execution module 111 may execute individual processes within the ETL pipeline, operating at a granular level. The process execution module 111 may run each defined process independently, one at a time, based upon the configuration and sequence determined by the workflow execution module 109. For each process, the process execution module 111 may retrieve the relevant script from library 119, access any specified input data, and apply the arguments provided in the configuration. The process execution module 111 may serve as the granular execution unit within the simulator, handling each ETL task in a controlled, isolated environment.

During execution, the process execution module 111 may pass arguments directly to the main function of each script, enabling the processes to access their required inputs and dependencies seamlessly. The process execution module 111 may read data from the input file, if provided, and may manage any necessary data transformations. Additionally, the process execution module 111 may direct output data to specified storage locations when an output path is indicated, ensuring that data flows correctly from one state to the next in the pipeline.

If a process encounters an error, the process execution module 111 may capture the error details and log them, allowing the workflow execution module 109 to halt further processing and initiate the error-handling and reporting routines. By facilitating the isolated execution and detailed monitoring of each process, the process execution module 111 may ensure that each task is executed accurately and independently, while allowing the workflow execution module 109 to efficiently control the overall workflow.

In one instance, the error handling module 113 may manage and respond to errors encountered during the execution of processes within the ETL pipeline. When a process fails, the error handling module 113 may intervene and handle the error based upon predefined protocols and parameters. The error handling module 113 may capture detailed information about the error, including its type, location, and any relevant process logs, and then determine the appropriate course of action. In one example, the error handling module 113 may initiate a series of automated corrective actions, including retrying the failed process, adjusting configurations or parameters as needed, or checking dependencies for potential issues. The retry mechanism may be driven by configurable parameters such as the maximum number of retries and intervals between attempts, allowing for the flexible handling of transient errors. Additionally, the error handling module 113 may trigger dependency resolution procedures, ensuring that any upstream or downstream processes that may have contributed to the failure are addressed before resuming execution.

The error handling module 113 may coordinate with the report generation module 115 to log error details and document the actions taken. In one scenario, the error handling module 113 may encounter a new error that may not be automatically resolved (e.g., an unexpected configuration error, data format issue, or previously unaccounted failure scenarios), whereupon the error handling module 113 may coordinate with the report generation module 115 to trigger a notification indicating a need for a user to manually review the issue, diagnose the root cause, and intervene with custom fixes. Once the issue is resolved, the error handling module 113 may enable the continuation of the workflow, either by resuming from the point of failure or a user-specified starting process. By combining automated error handling with the flexibility for expert intervention, the error handling module 113 may ensure that the ETL pipeline simulation remains robust, capable of handling known issues automatically, while allowing for resolution of new errors through developer’s input.

In one instance, the report generation module 115 may generate a comprehensive HTML report that may summarize the execution outcomes of the ETL pipeline simulation once the workflow execution has been completed or halted due to an error. The report generation module 115 may collect detailed information from each process within the pipeline, aggregate results, and structure the report to provide clear insights into the execution process. In one example, for each process that has been completed successfully, the report may include key data outputs that may be based upon the user-specified sample size. This may allow the user to inspect the data generated during the simulation and assess the accuracy of the pipeline’s processing at various stages. In another example, for each process that has failed, the report generation module 115 may record error details, including an error type, an error message, and any relevant logs. The report generation module 115 may identify the point of failure and may capture the context of the error, including how dependencies and input/output relationships may have contributed to the failure. Such a detailed breakdown of the failure may facilitate the user to understand the root cause of the failure.

In one instance, the visualization module 117 may generate a presentation of the ETL pipeline simulation in a visually intuitive format (e.g., display 121 in user device 123), aiding users in comprehending complex workflows and the associated data. As the workflow progresses, the visualization module 117 may continuously update the presentation (e.g., display 121) and present key metrics, execution time, process statuses, and data flow insights. This may include displaying the sequence of executed processes, the outcomes (success or failure), and any dependencies. In addition to real-time feedback, the visualization module 117 may interface with the report generation module 115 to display the final HTML report in an interactive format. In one example, in the event of an error during the pipeline execution, the visualization module 117 may highlight the failing process and provide a visual cue, such as color coding or annotations, to indicate where the error occurred. In another example, the report’s key findings, including detailed process outcomes, dependencies, and error details, may be presented in an easy-to-navigate layout, enabling users to explore and analyze the data pipeline results.

In one instance, the library 119 may include a centralized repository for storing and managing scripts and the corresponding dependencies for executing the data pipeline simulation. The library 119 may organize and store Python scripts, configuration files, and necessary third-party libraries, ensuring that each process in the workflow has access to the correct resources. The library 119 may also handle the installation of dependencies, manage the version control to ensure consistency, and support seamless integration of new or updated scripts, enabling the efficient and error-free simulation of the ETL pipeline.

In one instance, the user device 123 may include desktop computers, laptops, tablets, and/or smartphones. These devices typically feature robust hardware specifications, including multi-core processors, substantial RAM, and high-resolution displays to efficiently handle the demands of data-intensive tasks and complex JSON structures. The IDE environment upon these devices may provide a comprehensive suite of tools for coding, debugging, and/or visualizing JSON data to support features such as syntax highlighting, auto-completion, and integrated version control. In one example, desktop and laptop environments, such as those running upon Windows, macOS, or Linux, may offer a powerful and flexible platform, facilitating seamless multitasking and integration with external databases and/or services. For instance, tablets and smartphones may benefit from touch interfaces and portability, allowing for on-the-go coding and data analysis.

The various elements of the computing system 100 may communicate with each other through a communication network. In one instance, the user device 123 may include a network detection sensor for detecting wireless signals or receivers for different communications (e.g., Bluetooth, Wi-Fi, Li-Fi, Near Field Communication (NFC), etc.) from the communication network. The communication network may support a variety of different communication protocols and communication techniques.

In one instance, the communication network may allow the user device 123 (or one or more user devices) to communicate with the simulation platform 103. The communication network may include one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

The above presented modules and components of the simulation platform 103 may be implemented in hardware, firmware, software, or a combination thereof. Though depicted as a separate entity in FIG. 1, it is contemplated that the simulation platform 103 may be implemented for direct operation by the respective user device 123. As such, the simulation platform 103 may generate direct signal inputs by way of the operating system of the user device 123. In one instance, one or more of the modules 105-117 may be implemented for operation by the respective user device 123, as the simulation platform 103. The various executions presented herein contemplate any and all arrangements and models.

### EXEMPLARY SIMULATING INTEGRATION TESTING OF DATA PIPELINES FLOWCHART

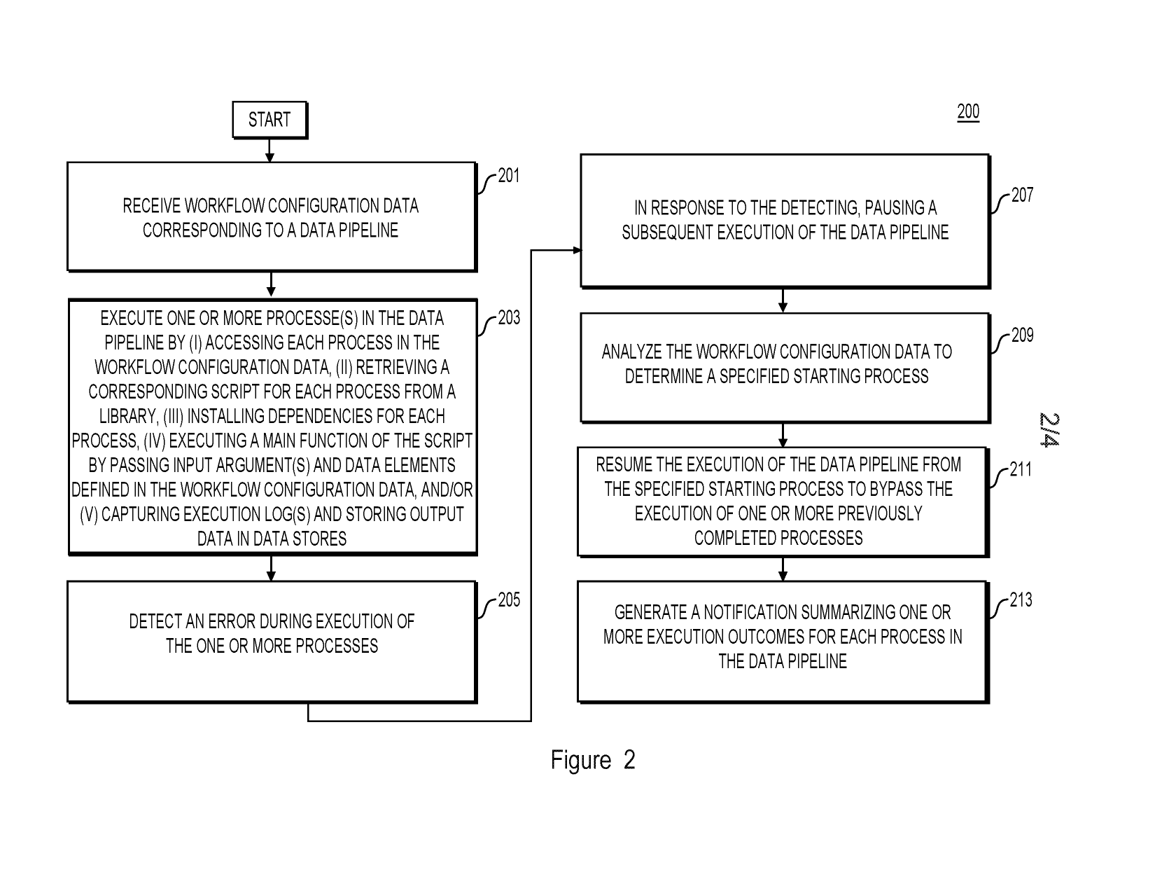

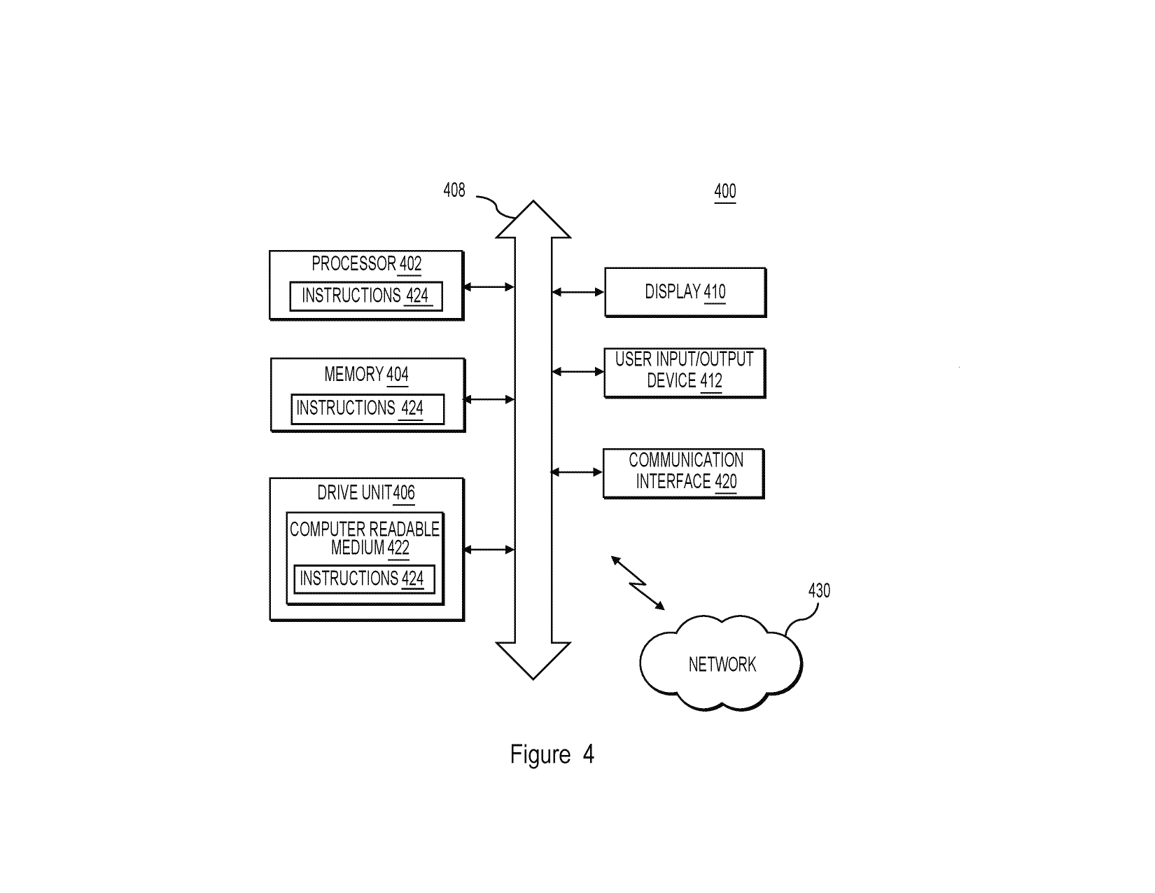

FIG. 2 is an exemplary flowchart of a computer-implemented or computer-based process for simulating and executing configurable workflows for integration testing of data pipelines. In one instance, the simulation platform 103 and/or any of the modules 105-117 may perform one or more portions of the process 200 and are implemented using, for instance, a chip set including a processor (e.g., processor 402) and a memory (e.g., memory 404) as shown in FIG. 4. As such, the simulation platform 103 and/or any of modules 105-117 may be configured to facilitate accomplishing various parts of the process 200, as well as accomplishing embodiments of other processes described herein in conjunction with other components of the computing system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the simulation platform 103 may receive workflow configuration data corresponding to a data pipeline. In one instance, the workflow configuration data may specify data for executing a series of sequential processes within the data pipeline. In one example, the workflow configuration data may include a sequence of processes for execution in a specified order, one or more dependencies for each process within the data pipeline, one or more arguments to pass to each process during the execution, and/or an indication of a starting process to begin the execution from a specified point within the sequence of processes. In another example, the workflow configuration data may include one or more parameters for a sample size of data to use during the execution of the data pipeline.

In block 203, the simulation platform 103 may execute one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores. In one instance, the simulation platform 103 may iterate over each process in the data pipeline based upon an order specified in the workflow configuration data. By iterating in this predetermined order, the simulation platform 103 may maintain workflow continuity, allowing each process to build upon the outputs of its predecessors or operate independently as specified. In another instance, the simulation platform 103 may store the retrieved script for each process in a library, and may access and execute each process directly from the stored script during one or more subsequent executions.

In one instance, the simulation platform 103 may verify the compatibility of one or more dependencies of each process before executing and logging one or more dependency conflicts. For example, the simulation platform 103 may check if the corresponding dependencies, such as specific libraries, frameworks, or version constraints, are compatible with the current environments or previously installed dependencies. If any conflicts are detected (e.g., incompatible versions or missing packages), the simulation platform 103 may log these conflicts for quick troubleshooting. Such preemptive checks may prevent runtime errors, ensuring that only compatible dependencies are present, and any issues are documented for review before execution continues.

The simulation platform 103 may isolate one or more dependencies of each process within a virtual environment to prevent dependency conflicts between the processes. By encapsulating dependencies in separate environments, the simulation platform 103 may ensure that each process runs with the exact library versions or settings, without interference from other processes’ configurations. This isolation may minimize the risk of dependency conflicts that may otherwise arise when different processes rely upon different versions of the same libraries, ensuring smoother execution of each process in the workflow.

In one instance, the workflow configuration data may include an input data location for each process of the one or more processes, allowing the simulation platform 103 to identify and load necessary data before executing a particular process. For each process, the input data location may be referenced in the configuration file, enabling the simulation platform 103 to fetch the specified data and prepare it as an input argument. When the simulation platform 103 reaches this process in the execution flow, it may load the data from the configured location and may pass it, along with any other required arguments, to the main function of the corresponding process script.

In one instance, an output data location may be specified for each process in the workflow configuration data. The output data may be written to a specified location after the execution of each respective process. For example, after a process executes, the simulation platform 103 may write the resulting data to the designated location specified in this configuration, ensuring an organized data flow and allowing subsequent processes to access or use this data if needed. This structured approach may support streamlined data management by automatically directing output data to predefined storage locations, facilitating efficient data retrieval and reference across the workflow.

In block 205, the simulation platform 103 may detect an error during the execution of one or more processes. In one instance, during the execution of a process, if an error occurs, whether due to missing dependencies, incorrect configurations, runtime exceptions, or unexpected input/output issues, the simulation platform 103 may identify and flag the error. The error may be logged with specific details, such as the process name, type of error, and any available context, to help diagnose the issue.

In block 207, the simulation platform 103 may pause a subsequent execution of the data pipeline in response to detecting the error. In one instance, the simulation platform 103 may initiate a set of error-handling protocols configured to iteratively re-execute one or more processes with the error, dynamically assess and resolve one or more missing or outdated dependencies, and/or apply one or more corrective configurations based upon one or more predefined error-handling parameters. In another instance, the simulation platform 103 may generate one or more recommendations corresponding to one or more corrective actions, one or more configuration adjustments, or one or more dependency checks in response to the detected error. In a further instance, the simulation platform 103 may directly generate a HTML report regarding the identified error, facilitating the users to take corrective actions efficiently without needing to rerun the entire pipeline.

In block 209, the simulation platform 103 may analyze the workflow configuration data to determine a specified starting process. This starting process, defined in the configuration file, may allow the simulation platform 103 to skip over initial processes and begin execution from the specified point. In one instance, when an error occurs during the execution of the data pipeline, it may often be attributed to common issues, such as (i) missing and/or invalid inputs in the workflow configuration or (ii) bugs that reside in the process script. After the error is detected and logged, the simulation platform 103 may halt further execution and provide the user with detailed feedback in the form of an HTML report. The HTML report may highlight the specific process that failed, the nature of the error, and/or any associated input/output dependencies or script-level issues.

The user may analyze the HTML report and make necessary adjustments to address the error. If the error is due to incorrect or incomplete inputs in the workflow configuration, the user may modify the configuration file to correct the issue. For example, the user may update paths to data files, correct parameter values, or refine the structure of inputs expected by the process. Alternatively, if the problem is linked to a bug within the process script, the user may access the “Lib” folder where the script is stored. By editing the script to resolve the identified issues, such as fixing syntax errors, updating logic, or refining external dependencies, the user may ensure the script is ready for successful re-execution. These changes may ensure that the pipeline is configured and prepared for successful execution.

In block 211, the simulation platform 103 may resume the execution of the data pipeline from the specified starting process to bypass the execution of one or more previously completed processes. By analyzing this data, the simulation platform 103 may read the user-defined parameters and directly initiate the workflow from the selected process, enabling efficient reruns and avoiding redundant executions of previously completed steps. This feature may streamline workflow testing and debugging by focusing only upon the targeted stages of the pipeline.

In block 213, the simulation platform 103 may generate a notification summarizing one or more execution outcomes for each process in the data pipeline. The notification may include one or more of: (i) an execution summary for each process within the data pipeline, (ii) a sample output based upon a user-defined sample size for each process, and/or (iii) one or more error details including one or more logs and relevant upstream process information contributing to the error. The notification may be dynamically updated and compiled as each process completes the execution, and the notification may include one or more intermediate logs for each process.

### EXEMPLARY DATA PIPELINE SIMULATION FLOWCHART

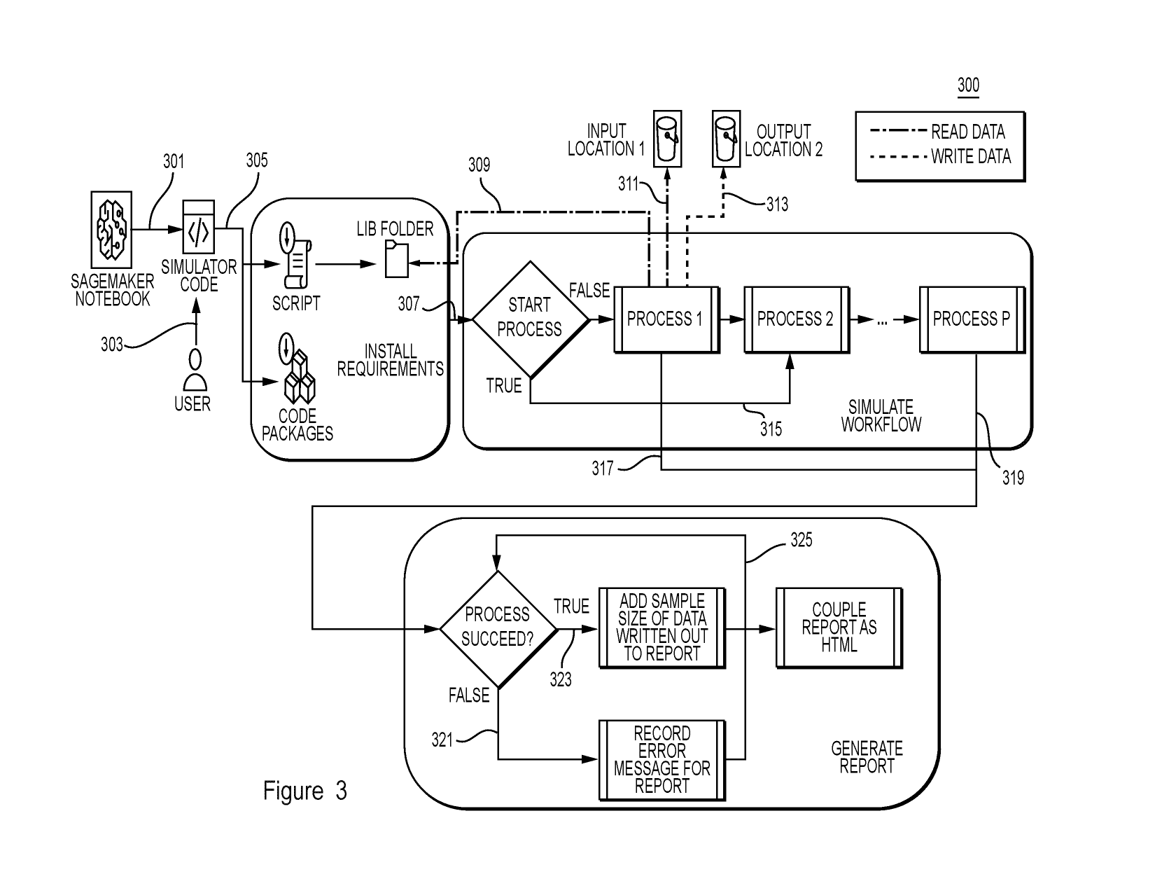

FIG. 3 is an exemplary flowchart of a computer-implemented or computer-based process for simulating the execution of a data pipeline with error handling and report generation. In one instance, the simulation platform 103 and/or any of the modules 105-117 may perform one or more portions of the process 300 and are implemented using, for instance, a chip set including a processor (e.g., processor 402) and a memory (e.g., memory 404) as shown in FIG. 4. As such, the simulation platform 103 and/or any of modules 105-117 may be configured to facilitate accomplishing various parts of the process 300, as well as accomplishing embodiments of other processes described herein in conjunction with other components of the computing system 100. Although the process 300 is illustrated and described as a sequence of actions, operations, and/or functionality, it is contemplated that various embodiments of the process 300 may be performed in any order or combination and need not include all of the illustrated actions, operations, and/or functionality.

In block 301, the user may set up the required infrastructure, such as a SageMaker notebook, with adequate CPU and memory resources to handle the data pipeline’s demands. This environment may provide the computational resources necessary for running the simulation platform 103 and executing each step in the workflow. This environment may also include the network permissions configured to enable seamless access to external data sources for reading input and writing output data, ensuring the simulation platform 103 can operate smoothly throughout the workflow.

In block 303, the user may import the simulator package into the environment and may provide key inputs, such as (i) the workflow configuration file (e.g., JSON file) outlining the workflow’s structure, including each process name and execution sequence, (ii) a sample size, an integer indicating the volume of data to test with and defining how many sample records will appear in the output HTML report, and (iii) the start process, allowing the user to define a specific process as the starting point, if the user wishes to resume from where they left off in the workflow.

In block 305, for each process defined in the workflow, the simulation platform 103 may install any corresponding scripts and dependencies. These scripts may be saved in a dedicated folder (e.g., Lib folder), enabling each process to run independently and ensuring all resources are in place before execution begins.

In block 307, the simulation platform 103 may initiate the workflow, moving sequentially through each process in the configuration. By iterating over each step in the defined order, the simulation platform 103 may systematically simulate the entire pipeline from start to finish.

In block 309, each of the processes (e.g., process 1, process 2, process P, etc.) may import its required scripts from the saved folder (e.g., Lib folder) and may run its main function, using the arguments specified in the workflow JSON file. This structured execution may ensure that each process adheres to its unique parameters and dependencies.

In block 311, during each process, if an input file is specified, the simulation platform 103 may pass the input file to the main function. The script may read the data, allowing the process to operate with the intended inputs as outlined in the configuration.

In block 313, if an output data location is designated, the process may write its result to the output data location. This may allow users to access and review the output generated by each process, supporting a clear flow of data through the pipeline.

In block 315, if the user specified a starting process (e.g., start_process parameter), the simulation platform 103 may begin execution from that point rather than at the beginning, This feature may streamline re-execution by resuming where needed without re-running successfully completed processes, thereby saving time and computational resources. In one example, the simulation platform 103 may verify the state of previous processes as it navigates to the specified start process, ensuring that dependencies and prerequisites are met, allowing for seamless continuation of the workflow without unnecessary reprocessing.

In block 317, if an error occurs during a process, the simulation platform 103 may halt further execution and initiate report generation. This early error capture may allow the users to diagnose issues without the need to complete the entire workflow. The report generation may consolidate the information upon the error, including the process name, the type of error encountered, and any dependencies involved. This structured approach may provide a clear log of the failure, making it easier for users to troubleshoot issues and resume execution from the portion of failure once corrections have been made.

In block 319, after all processes are complete, the simulation platform 103 may iterate through each process and may compile details into an HTML report. This summary may include both successful runs and errors, providing a comprehensive record of the pipeline’s execution.

In block 321, if any process encountered an error, the report may record the specific failure details. The simulation platform 103 may log each error and progress to finalizing the report, ensuring the user has visibility into issues encountered during execution. In one example, the simulation platform 103 may iterate over any failed processes, reattempting to execute until the process either succeeds or reaches a predefined retry limit.

In block 323, for successful processes, the report may include a sample of the output data as specified by the user. For example, if a user has specified a sample size of 10 records, then 10 representative records of output data are selected from the successful processes to be included in the report. This sampling may provide insight into the output for each process, creating a detailed report that may include both performance metrics and actual data results.

In block 325, after each process has been executed, the simulation platform 103 may compile the results of all processes into a comprehensive workflow report. This report may aggregate individual process outcomes, including any errors, sample data from successful executions, and execution details for each step. The final HTML report may provide a complete summary of the entire workflow, offering a structured view of each process’s performance, dependencies, and data flow across the pipeline.

### EXEMPLARY COMPUTING ENVIRONMENT

In general, any process or operation discussed in this disclosure is understood to be computer-implementable, such as the processes illustrated in FIGS. 2 and 3 may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 4 illustrates an implementation of a computer system that may execute techniques presented herein. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e.,programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 may include a cache or random-access memory for the processor 402. In alternative implementations, the memory 404 is separate from the processor 402, such as a cache memory of a processor, the system memory, or other memory.

The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, computer-readable medium 422 may include the set of instructions 424 or receives and executes the set of instructions 424 responsive to a propagated signal so that a device connected to network 430 can communicate voice, video, audio, images, or any other data over the network 430. Further, the set of instructions 424 may be transmitted or received over the network 430 via communication port or interface 420, and/or using bus 408. The communication port or interface 420 may be a part of the processor 402 or may be a separate component. The communication port or interface 420 may be created in software or may be a physical connection in hardware. The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 430. The network 430 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication.

The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices.

The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like.

### EXEMPLARY EMBODIMENTS

A computer-implemented method for simulating and executing configurable workflows for integration testing of data pipelines may be provided. The computer-implemented method may be performed by one or more local or remote processors of a computing system in communication with one or more local or remote data sources. The computer-implemented method may include: (1) receiving, by one or more processors, workflow configuration data corresponding to a data pipeline, wherein the workflow configuration data specifies data for executing a series of sequential processes within the data pipeline; (2) executing, by the one or more processors, one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores; (3) detecting, by the one or more processors, an error during execution of the one or more processes; (4) in response to the detecting, pausing, by the one or more processors, a subsequent execution of the data pipeline; (5) analyzing, by the one or more processors, the workflow configuration data to determine a specified starting process; (6) resuming, by the one or more processors, the execution of the data pipeline from the specified starting process to bypass the execution of one or more previously completed processes; and/or (7) generating, by the one or more processors, a notification summarizing one or more execution outcomes for each process in the data pipeline.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

In certain aspects, pausing the subsequent execution of the data pipeline may include initiating, by the one or more processors, a set of error-handling protocols configured to (i) iteratively re-execute the one or more processes with the error, (ii) dynamically assess and resolve one or more missing or outdated dependencies, and/or (iii) apply one or more corrective configurations based upon one or more predefined error-handling parameters.

In certain embodiments, pausing the subsequent execution of the data pipeline may include generating, by the one or more processors, (i) one or more recommendations corresponding to one or more corrective actions, (ii) one or more configuration adjustments, and/or (iii) one or more dependency checks in response to the detected error.

In various embodiments, the workflow configuration data may include one or more of: (i) a sequence of processes to execute in a specified order, (ii) the one or more dependencies for each process within the data pipeline, (iii) one or more arguments to pass to each process during the execution, and/or (iv) an indication of a starting process to begin the execution from a specified point within the sequence of processes.

In some embodiments, the workflow configuration data may include one or more parameters for a sample size of data to use during the execution of the data pipeline.

In certain aspects, the retrieved script for each process may be stored, by the one or more processors, in a library. A simulator may access and execute each process directly from the stored script during one or more subsequent executions.

In some embodiments, compatibility of the one or more dependencies of each process may be verified, by the one or more processors, prior to executing and logging one or more dependency conflicts. The one or more dependencies of each process may be isolated, by the one or more processors, within a virtual environment to prevent the one or more dependency conflicts between the one or more processes.

In certain aspects, the workflow configuration data may include an input data location for each process of the one or more processes. The one or more input arguments may be passed to the main function of a respective process script during the execution.

In some aspects, an output data location may be specified for each process in the workflow configuration data. The output data may be written to a specified location after the execution of each respective process.

In certain embodiments, a simulator may iterate over each process in the data pipeline based upon an order specified in the workflow configuration data.

Additionally or alternatively, the notification may include one or more of: (i) an execution summary for each process within the data pipeline, (ii) a sample output based upon a user-defined sample size for each process, and/or (iii) one or more error details including one or more logs and relevant upstream process information contributing to the error.

In some embodiments, the notification may be dynamically updated and compiled as each process completes the execution. The notification may include one or more intermediate logs for each process.

A computer system for simulating and executing configurable workflows for integration testing of data pipelines may be provided. The computer system may include one or more processors of a computing system, and at least one non-transitory computer readable medium storing instructions which, when executed by the one or more processors, cause the one or more processors to perform operations. The computer system may perform operations including (1) receiving workflow configuration data corresponding to a data pipeline, wherein the workflow configuration data specifies data for executing a series of sequential processes within the data pipeline; (2) executing one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores; (3) detecting an error during execution of the one or more processes; (4) in response to the detecting, pausing a subsequent execution of the data pipeline; (5) analyzing the workflow configuration data to determine a specified starting process; (6) resuming the execution of the data pipeline from the specified starting process to bypass the execution of one or more previously completed processes; and/or (7) generating a notification summarizing one or more execution outcomes for each process in the data pipeline.

In certain aspects, pausing the subsequent execution of the data pipeline may include initiating a set of error-handling protocols configured to (i) iteratively re-execute the one or more processes with the error, (ii) dynamically assess and resolve one or more missing or outdated dependencies, and/or (iii) apply one or more corrective configurations based upon one or more predefined error-handling parameters.

In certain embodiments, pausing the subsequent execution of the data pipeline may include generating (i) one or more recommendations corresponding to one or more corrective actions, (ii) one or more configuration adjustments, and/or (iii) one or more dependency checks in response to the detected error.

In some aspects, the workflow configuration data may include one or more of: (i) a sequence of processes to execute in a specified order, (ii) the one or more dependencies for each process within the data pipeline, (iii) one or more arguments to pass to each process during the execution, and/or (iv) an indication of a starting process to begin the execution from a specified point within the sequence of processes.

Additionally or alternatively, the workflow configuration data may include one or more parameters for a sample size of data to use during the execution of the data pipeline.

A non-transitory computer readable medium for simulating and executing configurable workflows for integration testing of data pipelines may be provided. The non-transitory computer readable medium may store instructions which, when executed by one or more processors, cause the one or more processors to perform operations. The one or more processors may perform operations including: (1) receiving workflow configuration data corresponding to a data pipeline, wherein the workflow configuration data specifies data for executing a series of sequential processes within the data pipeline; (2) executing one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores; (3) detecting an error during execution of the one or more processes; (4) in response to the detecting, pausing a subsequent execution of the data pipeline; (5) analyzing the workflow configuration data to determine a specified starting process; (6) resuming the execution of the data pipeline from the specified starting process to bypass the execution of one or more previously completed processes; and/or (7) generating a notification summarizing one or more execution outcomes for each process in the data pipeline.

In certain aspects, pausing the subsequent execution of the data pipeline may include initiating a set of error-handling protocols configured to (i) iteratively re-execute the one or more processes with the error, (ii) dynamically assess and resolve one or more missing or outdated dependencies, and/or (iii) apply one or more corrective configurations based upon one or more predefined error-handling parameters.

In certain embodiments, pausing the subsequent execution of the data pipeline may include generating (i) one or more recommendations corresponding to one or more corrective actions, (ii) one or more configuration adjustments, and/or (iii) one or more dependency checks in response to the detected error.

### ADDITIONAL CONSIDERATIONS

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e.,computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for simulating and executing configurable workflows for integration testing of data pipelines, comprising:
receiving, by one or more processors, workflow configuration data corresponding to a data pipeline, wherein the workflow configuration data specifies data for executing a series of sequential processes within the data pipeline;
executing, by the one or more processors, one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores;
detecting, by the one or more processors, an error during execution of the one or more processes;
in response to the detecting, pausing, by the one or more processors, a subsequent execution of the data pipeline;
analyzing, by the one or more processors, the workflow configuration data to determine a specified starting process;
resuming, by the one or more processors, the execution of the data pipeline from the specified starting process to bypass the execution of one or more previously completed processes; and
generating, by the one or more processors, a notification summarizing one or more execution outcomes for each process in the data pipeline.

2. The computer-implemented method of claim 1, wherein pausing the subsequent execution of the data pipeline further comprises:
initiating, by the one or more processors, a set of error-handling protocols configured to iteratively re-execute the one or more processes with the error, dynamically assess and resolve one or more missing or outdated dependencies, and/or apply one or more corrective configurations based upon one or more predefined error-handling parameters.

3. The computer-implemented method of claim 1, wherein pausing the subsequent execution of the data pipeline further comprises:
generating, by the one or more processors, one or more recommendations corresponding to one or more corrective actions, one or more configuration adjustments, or one or more dependency checks in response to the detected error.

4. The computer-implemented method of claim 1, wherein the workflow configuration data includes one or more of: (i) a sequence of processes to execute in a specified order, (ii) the one or more dependencies for each process within the data pipeline, (iii) one or more arguments to pass to each process during the execution, or (iv) an indication of a starting process to begin the execution from a specified point within the sequence of processes.

5. The computer-implemented method of claim 1, wherein the workflow configuration data further includes one or more parameters for a sample size of data to use during the execution of the data pipeline.

6. The computer-implemented method of claim 1, the method further comprising:
storing, by the one or more processors, the retrieved script for each process in a library, wherein a simulator accesses and executes each process directly from the stored script during one or more subsequent executions.

7. The computer-implemented method of claim 1, the method further comprising:
verifying, by the one or more processors, a compatibility of the one or more dependencies of each process prior to executing and logging one or more dependency conflicts; and
isolating, by the one or more processors, the one or more dependencies of each process within a virtual environment to prevent the one or more dependency conflicts between the one or more processes.

8. The computer-implemented method of claim 1, wherein the workflow configuration data includes an input data location for each process of the one or more processes, and wherein the one or more input arguments are passed to the main function of a respective process script during the execution.

9. The computer-implemented method of claim 1, wherein an output data location is specified for each process in the workflow configuration data, and wherein the output data is written to a specified location after the execution of each respective process.

10. The computer-implemented method of claim 1, wherein a simulator iterates over each process in the data pipeline based upon an order specified in the workflow configuration data.

11. The computer-implemented method of claim 1, wherein the notification includes one or more of: (i) an execution summary for each process within the data pipeline, (ii) a sample output based upon a user-defined sample size for each process, or (iii) one or more error details including one or more logs and relevant upstream process information contributing to the error.

12. The computer-implemented method of claim 1, wherein the notification is dynamically updated and compiled as each process completes the execution, and wherein the notification includes one or more intermediate logs for each process.

13. A computer system for simulating and executing configurable workflows for integration testing of data pipelines, comprising:
one or more processors of a computing system; and
at least one non-transitory computer readable medium storing instructions which, when executed by the one or more processors, cause the one or more processors to perform operations comprising:
receiving workflow configuration data corresponding to a data pipeline, wherein the workflow configuration data specifies data for executing a series of sequential processes within the data pipeline;
executing one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores;
detecting an error during execution of the one or more processes;
in response to the detecting, pausing a subsequent execution of the data pipeline;
analyzing the workflow configuration data to determine a specified starting process;
resuming the execution of the data pipeline from the specified starting process to bypass the execution of one or more previously completed processes; and
generating a notification summarizing one or more execution outcomes for each process in the data pipeline.

14. The system of claim 13, wherein pausing the subsequent execution of the data pipeline further comprises:
initiating a set of error-handling protocols configured to iteratively re-execute the one or more processes with the error, dynamically assess and resolve one or more missing or outdated dependencies, and/or apply one or more corrective configurations based upon one or more predefined error-handling parameters.

15. The system of claim 13, wherein pausing the subsequent execution of the data pipeline further comprises:
generating one or more recommendations corresponding to one or more corrective actions, one or more configuration adjustments, or one or more dependency checks in response to the detected error.

16. The system of claim 13, wherein the workflow configuration data includes one or more of: (i) a sequence of processes to execute in a specified order, (ii) the one or more dependencies for each process within the data pipeline, (iii) one or more arguments to pass to each process during the execution, or (iv) an indication of a starting process to begin the execution from a specified point within the sequence of processes.

17. The system of claim 13, wherein the workflow configuration data further includes one or more parameters for a sample size of data to use during the execution of the data pipeline.

18. A non-transitory computer readable medium for simulating and executing configurable workflows for integration testing of data pipelines, the non-transitory computer readable medium storing instructions which, when executed by one or more processors of a computing system, cause the one or more processors to perform operations comprising:
receiving workflow configuration data corresponding to a data pipeline, wherein the workflow configuration data specifies data for executing a series of sequential processes within the data pipeline;
executing one or more processes in the data pipeline by (i) accessing each process in the workflow configuration data, (ii) retrieving a corresponding script for each process of the one or more processes from a library, (iii) installing one or more dependencies for each process, (iv) executing a main function of the script by passing one or more input arguments and data elements defined in the workflow configuration data, and/or (v) capturing one or more execution logs and storing output data in one or more data stores;
detecting an error during execution of the one or more processes;
in response to the detecting, pausing a subsequent execution of the data pipeline;
analyzing the workflow configuration data to determine a specified starting process;
resuming the execution of the data pipeline from the specified starting process to bypass the execution of one or more previously completed processes; and
generating a notification summarizing one or more execution outcomes for each process in the data pipeline.

19. The non-transitory computer readable medium of claim 18, wherein pausing the subsequent execution of the data pipeline further comprises:
initiating a set of error-handling protocols configured to iteratively re-execute the one or more processes with the error, dynamically assess and resolve one or more missing or outdated dependencies, and/or apply one or more corrective configurations based upon one or more predefined error-handling parameters.

20. The non-transitory computer readable medium of claim 18, wherein pausing the subsequent execution of the data pipeline further comprises:
generating one or more recommendations corresponding to one or more corrective actions, one or more configuration adjustments, or one or more dependency checks in response to the detected error.
